(19) United States
(12) Patent Application Publication
(10) Pub. No.: US 2019/0097811 A1
(43) Pub. Date: Mar. 28, 2019

(54) OPEN, SECURE ELECTRONIC SIGNATURE SYSTEM AND ASSOCIATED METHOD

(71) Applicant: LEX PERSONA, Troyes (FR)

(72) Inventors: François DEVORET, Troyes (FR); Julien PASQUIER, Marrakech (FR)

(73) Assignee: LEX PERSONA, Troyes (FR)

(21) Appl. No.: 16/081,161

(22) PCT Filed: Feb. 28, 2017
(86) PCT No.: PCT/IB2017/051168

§ 371 Date: Aug. 30, 2018

(30) Foreign Application Priority Data
Mar. 1, 2016 (FR) 16/70070

(51) Int. Cl. H04L 9/32; G06F 21/60; G06F 21/64; H04L 29/06

(52) U.S. Cl. CPC H04L 9/3247; H04L 9/3263; H04L 63/126; G06F 21/602; G06F 21/645; H04L 9/3297

(57) ABSTRACT

Open and secure electronic signature system comprising a business application (10), said business application having a programming interface (42) configured to request a signature of a document (20) with a signature manager (40) for a user (30), the system is characterized in that said business application (10) is able to define a content to be signed, to identify criteria and to select a signatory user (30), to define the use of a type of digital identity, to collect signature properties, and to require a signature format. The signature manager (40) is able to coordinate said signature request by performing the following steps: —verification of the identity and the authorization of the business application (10), —verification of the identity of the user signatory (30), —recovery of the document (20) to be signed, —preparation of the signature request with fingerprint calculations of the data to be signed, —sending a notification of the signature request to signature services (60) of the user (30). The user (30), by means of said signature services (60), is able to control the execution of the signature process by activating the private key corresponding to a certificate (61) of the user (30) meeting the criteria selection keys sent to said signature manager (40) by the business application (10) for encrypting the fingerprint of the data to be signed. The invention further relates to the method of preparing and processing a signature request implemented in the above system.

### TECHNICAL FIELD OF THE INVENTION

The invention relates to the field of electronic signature. More particularly, the invention relates to an open and secure system for signing an electronic document. The invention further relates to a method for preparing and processing a signature request.

### STATE OF THE PRIOR ART

The electronic signature mainly consists in allowing a human user to encrypt the fingerprint of a document to be signed, with a private key corresponding to a public key associated with his identity, this private key being generally protected by a cryptographic device and a secret code, the result of the encryption then to be incorporated or associated with the document to be signed so as to constitute a proof. During this operation, it is necessary to ensure that the association between the public key and the identity of the signatory is certified by an authority compatible with the security and trust requirements associated with the electronic signature, that this certification be verified as still valid, and that the signatory agrees with the content to be signed.

Moreover, the sequence of calculation, management and verification tasks necessary for the realization of an electronic signature is excessively complex. Indeed, the algorithms on which the calculations are based must themselves be compatible with the requirements of security and confidence. In addition, the data to be signed are not necessarily directly accessible by the signature process but can be remote, that the same data to be signed must be able to be framed by contextual elements such as the date and time of the signature, the signatory certification chain, role, signature location, signature policy, etc. Moreover, the private key can be on a local or remote cryptographic device of the user, and the environment of these operations is sometimes on the user's workstation, but can also be remote or run in client-server mode in a web browser, or on a smartphone or tablet.

Document EP 1393144 B1 discloses a method and a web-based system for legally enforceable signature of documents in a Web environment. The system includes first access means for accessing the web environment from an electronic system, and also includes a plurality of modules. A rendering module of the document for presenting to the user a web representation of the document, a legal information module for presenting to the user, in the Web environment, legal information relating to the electronic signature of the document, and to obtain the agreement of the user of this legal information. A document approval module to integrate the user's signature into the document, with the user's consent legal information. The system also includes a logging module for generating a log of the signature processes of the document by associating this log of the process with the signed document. Finally, a document distribution module to make the signed document available. This document concerns the traceability of the process. There is a particular need to streamline the electronic signature process and also to mask the complexity of the process to users.

### SUMMARY OF THE INVENTION

The invention therefore aims, on the one hand, to streamline the electronic signature process, to break it down into independent tasks whose interactions between them will be secured by exchange protocols specifically designed for this purpose, and, on the other hand, to mask this complexity to the users of the electronic signature and the business applications that wish to implement it. To do this, it is proposed an open and secure electronic signature system comprising a business application, developed and executed in various environments, said business application having a programming interface configured to request a signature of a document from a signature manager for a user. The system is characterized in that said business application is able to define a content to be signed, to identify criteria and to select a signatory user, to define the use of a type of digital identity, that it is moreover able to perform a collection of signature properties and to require a signature format. Said signature manager is able to coordinate said signature request by performing the following steps:—verification of the identity and the authorization of the business application;—verification of the identity of the signatory user;—recovery of the document to be signed;—preparation of the signature request with fingerprint calculations of the data to be signed, via signature servers; sending a notification of the signature request via a notification server to the signature services of the user. The user by means of said signature services is able to control the execution of the signature process by activating the private key corresponding to a certificate of the user meeting the selection criteria sent to said signature manager by the business application in question view of the encryption of the fingerprint of the data to be signed.

According to particular features, the signature manager is able to identify the identity of the signing user by means of a user directory managed by said signature manager. Data fingerprint calculations are performed either by a signature server or by a reverse signature server. The signature manager is furthermore able to recover the signatures made and to send said signatures to the business application. The notification server being configured to notify said business application in advance of the arrival of said signatures.

According to particular features, the system further comprises timestamped and archived log files, in which are written the steps of the signature transaction. The signature manager is configured to manage said log files so as to constitute a proof file for each signature transaction.

Preferably, the signature service is a lightweight and downloadable software component on a device of the user and in that said device is a PC and/or a Mac and/or a tablet and/or a said user's smartphone.

According to particular features, the system further comprises a personal signature manager belonging to the user and that the business application is able of executing a signature request with said personal signature manager. Said personal signature manager executes on a device of said user so as to allow said user to sign a document in local mode when there is no available internet connection or that the signature manager is not usable in this context.

According to particular features, the system further comprises a local signature creation device in the form of a hardware or software component, and/or a remote signature creation device and that the user is capable of signing the document either using said local signature creation device using the hardware component, such as a cryptographic device, or the software component, such as a software certificate accessible on the user's device, or using the remote signature creation device, said remote signature creation device being able to incorporate a certificate generated on-the-fly, during a displacement of said user. The certificate generated on-the-fly is a certificate generated for single use.

Advantageously, said certificates generated on-the-fly are generated so that they have a security level consistent with the requirements formulated in the signature request sent by the business application and in that they are able to perform the task encrypting the fingerprint of the data to be signed by an associated private key.

According to particular features, the business application accesses the data to be signed said data to be signed are located either in the local environment of said business application, or in the network environment of said business application.

According to particular features, the local signature creation device is in the form of a cryptographic chip or a software certificate, the user locally accesses said local signature creation device from his device, said device being a workstation, or a smartphone or tablet.

According to particular features, the remote signature creation device is characterized in that it is located in the network environment of the signature manager and contains a certificate generated on-the-fly, and that the system comprises a key management infrastructure capable of generating said certificate on-the-fly, and in that the private key associated with said on-the-certificate is generated and securely stored by the signature servers.

Preferably, the signature manager by means of the notification server is able to notify the signature request of the document to the signature services of the user and that the notification server is associated with an environment of execution of said signature services.

Preferably, the signature service is configured to register with the notification server associated with its execution environment and is able to communicate with the signature manager to indicate that he knows the details information enabling said signature manager to notify him.

The invention also relates to a method for preparing and processing a signature application, by a business application, of a document with a signature manager for a user, registered and identified with said signature manager, said method being implemented in the system described above and comprises the following steps:
connecting a user to the business application to sign a document;
recovery by the business application of the document to be signed;
interrogation of the signature manager by the business application to identify the user who must sign the document;
sending a signature request to said signature manager by the business application, said request includes a content to be signed, criteria for identifying and selecting the signatory user, a type of digital identity to be used, performs signature property collection and requires a signature format;
coordination of the signature transaction steps by the signature manager comprising the following steps:
   verification of the identity and the authorization of the business application;
   verification of the identity of the signatory user;
   recovering said document to be signed with the business application;
   preparation of the signature request with the calculation of the fingerprint of the data to be signed, via signature servers;
   sending a notification of the signature request to a signature service of the user via a notification server;
   control of the execution of the signature process by the signature service, by activating a private key corresponding to a certificate of the user meeting the selection criteria sent to the signature manager by the business application;
   timestamping and saving transaction events in logs;
   sending to the business application the result of the operations after notification, or any errors encountered;
recovery by the business application of the result of operations;
provision of the user by the business application of the result of the operations.

### BRIEF DESCRIPTION OF THE FIGURES

Other features, details and advantages of the invention will become apparent on reading the description which follows, with reference to the appended figures, which illustrate:

FIG. 2 illustrates the general architecture of the system according to the present invention;

FIG. 2 illustrates the steps of the method implemented in the system according to the invention;

For clarity, identical or similar elements are identified by identical reference signs throughout the figures.

### DETAILED DESCRIPTION

FIG. 1 shows the general architecture of the system according to the present invention. This architecture represents, on the one hand, the environment 1 of a user 30 of the system and, on the other hand, the internet environment 2 of a signature manager 40. A user 30 is a natural person who wishes or must sign one or several documents.

The distinction between a signature made at the initiative of the user or solicited by a third party (other user) is essential. Indeed, the user experience is very different because, in the first case, it necessarily implies a preparation related to the choice of the document, its drafting, the selection of the digital identity and its implementation, to the possible signature policy to apply, etc., whereas in the second case, it requires a particular ease of action regarding access to the document and the digital identity of the signatory to focus on the probative value of the transaction, possibly forcing the user, before signing, to read the entire document, to authenticate to prove his digital identity, etc.

The architecture of the system as shown in FIG. 1 comprises a business application 10, said business application can be developed and executed in various environments such as web servers, Internet browsers, in a native environment PC or Mac, or from a mobile phone or tablet. The business application is at the origin of the signature process, thus, any request for signature, whether made at the initiative of the signatory user 30 himself, or whether it is done by a third party to have a document signed, must necessarily go through this business application 10. Said business application 10 is designed so that it is able to make a request for signing a document 20 to a signature manager 40 for a user 30. To do this, the business application 10 contains a programming interface 42, developed with specific libraries, enabling it to communicate with the signature manager 40. The purpose of the business application 10 according to the invention is to define the specification of the signature (s) to be made, that is define a content to be signed, criteria for identifying and selecting a signatory user 30, a type of naked identity to use, perform a collection of signature properties, require a signature format.

The business application 10 submits this signature request to the central component of the system, namely the signature manager 40. The role of the signature manager 40 is to process a signature request of the business application 10 and to coordinate its execution by following the following steps: verification of the identity and the authorization of the business application 10, taking into account the request, identification of the signing user 30, recovery of the document 20 to sign indicated by the business application, preparation of the signature request with the fingerprint calculation of the data to be signed, via a signature server 50 or 51, notification of the signature request, via a notification server 70 to all the services of signatures 60 of the user 30, and finally providing the results of operations to the business application 10. Said signature manager 40 verifies the identity of the signing user 30 by means of a user directory 41. Said user directory 41 is associated and managed by a set of signatures of managers 40.

The document or documents 20 to be signed may be located in the local environment of the business application 10 called “local DTBS” 21 (local DTBS signify the local data to be signed) generally on a device of the user, and accessible locally by this one; in this case, it is the responsibility of the business application 10 to retrieve this data to compose the signature request to be sent to the signature manager 40. The documents to be signed may also be located in the network environment of the business application 10 called “DTBS remote” 22 (remote DTBS signify the remote data to be signed), typically in a GED (electronic document management tool) to which the business application 10 accesses, which will thus be able to upload this data to the signature manager 40.

After the recovery of the document(s) 20 to be signed by the signature manager 40, it prepares the request(s) signature(s) with fingerprint calculations of the data to sign, namely the contents of the document (s) as well as the properties. These fingerprint calculations of the data are performed either by a signature server 50 or by an inverse signature server 51.

The system comprises a signature creation device 61, it is a hardware or software component that makes to encrypt the fingerprint of the data to be signed by the private key associated with the certificate of the signatory user 30. Said signature creation device 61 may be located in the user's local environment 30 and be accessible only by the latter, typically in the form of a cryptographic device (smart card, cryptographic USB token) or software certificate accessible locally from the user's workstation or from his mobile terminal (smartphone, tablet). The signature creation device 61 may also be located in the network environment of the signature manager 40, referenced 62 in the figure, typically in the form of a certificate generated on-the-fly by a key management infrastructure. Indeed, the signature manager 40 can instruct said key management infrastructure to generate this certificate on-the-fly. In addition, the private key associated with said certificate on-the-fly of the user 30 is generated and securely stored by the signature servers. The idea is therefore, for each signature, to generate a “certificate on-the-fly” or “single use” valid for one use only.

The signature server 50 is a centralized signature server to which the signature manager 40 sends a signature request. A typical example of the signature server 50 is the LP7SignBox software developed by the company Lex Persona (applicant), but it could be envisaged to access other signature servers respecting, for example, the OASIS DSS protocol (Digital Signature Service).

The reverse signature server 51 is a decentralized signature server called by the signature manager 40 to compose the signature in a desired format, for example, for signatures, according to the formats: CAdES, PAdES, XAdES etc. Said reverse signature server 51 is also able to calculate the hash of the data to be signed in the case of a decentralized signature request. This fingerprint will be sent by the signature manager 40 to the signature service 60 of the user 30. The signature service 60 then uses a signature creation device 61 to encrypt the fingerprint with the private key and returns the result of the signature generated to the signature manager 40 which in turn transmits it to the reverse signature server 51 which then finalizes the composition of the signature. A typical example of a reverse signing server that offers the above functionality is the LP7SignBox software developed by Lex Persona (Applicant). This case is particularly suitable for the decentralized signature with a local signature creation device 61 in the form of a cryptographic device made from a mobile terminal of the user (smartphone or tablet).

Furthermore, the signature manager 40 notifies the signature services 60 of the signing user 30 by means of a notification server 70 in order to notify said user to sign the document or documents 20. For that, the signature manager 40 sends notifications to the notification servers (push) 70 associated with the signature services 60 of the user 30. It is therefore necessary for a signature service 60 to be able to register, as soon as it is launched, with the notification server (push) 70 associated with its execution environment, for example: GCM for Android, APN for Apple, WNS for Windows, etc. The signature service 60, associated with the device of the user, then communicates to the signature managers 40 that he knows the information that will allow them to notify it. A signature service 60 thus has a configuration file containing the list of signature managers 40 with which it can declare itself.

A signature service 60 is a universal personal application, which allows the user 30 to control the execution of the signature process, namely the activation of the private key corresponding to one of the certificates of the user 30 meeting the selection criteria sent to the signature manager 40 by the business application 10, for the purpose of encrypting the fingerprint of the data to be signed. Due to the separation between the business application 10, to which the signatory user 30 generally has access, and the signature service 60, said signature service 60 may be qualified as a companion application. The signature service 60 is a software component that is as light as possible so that it can be downloaded quickly and takes up the least possible space on the user's device 30. The user interface of the signature service 60 is very simple and intuitive with a graphic identity as general as possible. The signature service 60 is able to sign in local mode. Indeed in a mobile environment, an Internet connection may be absent for a longer or shorter time, in which case the signature service 60 is able to finalize the signature without an Internet connection, or automatically as soon as the Internet connection is new effective.

A user 30 may have several signature services 60, so it is for example possible for the user 30 to sign with a local signature creation device 61, from his workstation Windows or Mac when he is at his desk, using a hardware component (smart card) or software (certificate), or to sign from his smartphone while on the move, with a remote signature creation device 62 in the form of a certificate generated on-the-fly. Only if the security level of the certificate on-the-fly complies with the requirements formulated in the signature request sent by the business application 10 to the signature manager 40.

The signature manager 40 is able to recover the signature(s) once thay have been performed and, in the case of enveloping signatures or wrapped, it proceeds to the formatting of the signature(s) performed. It is also able to make available to the business application 10 the result of the operations performed or errors possibly encountered. Indeed, all the steps of the signature operations managed by the signature manager 40 are written in logs. These logs are time stamped and archived to form a complete and secure proof file for each signature transaction.

In some cases it may be necessary for a user to sign one or more documents while no Internet connection is available or that the signature manager is not usable, we will say in this case of signature in local mode. Such cases may arise when it is necessary to sign during a trip or in the case where there is no Internet connection or the absence of the network. In this case, according to the present invention, the business application 10 may submit the signature request to a personal signature manager, not shown in the figure. Said personal signature manager is personal in that it is in the local environment of the user and in that it executes on his personal workstation, whatever the typology of said workstation, tablet, smartphone, etc. . . . Said personal signature manager is able to perform and coordinate all steps of the signature process like the signature manager. It should be noted that the personal signature manager can also be requested by the business application even if the user has an Internet connection in order to have it signed directly without going through a signature manager.

The user directory 41 is associated and managed by a set of signature managers 40. The users can be of three categories. The “Anonymous” user: This user is unique by signature manager 40, he is undefined and unauthenticated. “Virtual” user: This user is partially defined and not authenticated. The “Qualified” user: This user is completely defined and authenticated by the signature manager 40.

In the case of a business application that wishes to immediately sign the user who is using it, it is not necessary to authenticate in any way said user, since that it is already authenticated by the business application. Thus, the business application will signify to the signature manager that it already knows the user, which is anonymous for the signature manager, but not for the business application. In this case, the business application can take care of launching the user's signature service and send the signature request to the personal signature manager that can be packaged with the signature service. Possibly, if the user already has an account on a signature manager of his choice, he can connect to possibly retrieve different information and credit his account of the signature that will be made.

In the case of a business application that wishes to immediately sign the user, without the need to benefit from a user already referenced by the signature manager used (“fast signature”), we trust in advance the user who meets certain criteria, then the business application will signify the signature manager that it will be satisfied with a ‘Virtual user’ who will meet certain criteria (email, cell phone number, etc.). Optionally, if the user already has an account on the signature manager specified by the business application, he can connect in to possibly retrieve different information and credit his account of the signature that will be made.

In the case of a business application that wishes to immediately sign a user that it knows as being defined and authenticated by the signature manager, then it can specify a ‘Qualified User’. The user will then have to authenticate on the signature manager requested by said business application to sign the document(s).

Each Qualified user has the following data: User ID, SHA256 fingerprint of the user's password, surname and first name and/or alias, date of birth, phone number on which it is possible to address short messages, mail address, pushTokenIDs corresponding to the devices on which it is possible to notify the user when it is the subject of a signature request, the user's certificates and the associated signature creation device reference. Some of this data is optional and may not be in the directory. This user directory 41 will enable a signature manager 40 to identify the signatory designated by a signature request sent to it by a business application 10, to select the appropriate certificate corresponding to the signature request, to access the user's pushTokenIDs for notify it, to notify this user that he/she is the subject of a signature request on the various signature services capable of processing the signature request.

In the system of the invention, three other modules are present but do not appear in FIG. 1 for reasons of readability. Thus, the system includes a directory of signature managers. Indeed, from the moment when it is possible to have different signature managers each capable of processing requests for signatures from different business applications, it is possible to give the possibility to a business application to send a request for authorization signing not to a specific signature manager, but to query a signature manager directory in order to be able to identify the most appropriate signature manager to process the request. Also, if for example a business application allows a user to declare the fee on the company, it might be convenient for the business application to query a directory of signature managers to select the “national” signature manager that will allow the company to declare its tax in the country of the company.

Another module of the system of the invention is the IGC server. Indeed, in the architecture of the invention, the IGC server designates a public key management infrastructure server. Its role is to deliver certificates on-the-fly to users and whose associated private keys are securely stored by a signature server that will perform the signature requests that will be assigned to them.

Finally a last module is a timestamp authority (TSA: Time StampAuthority) issuing timestamp tokens. In fact, in the system of the invention, certain modules require the possibility of calling on a timestamp, such as the writing of all the steps of the signature transaction in timestamped logs or else the timestamp of the electronic signatures generated.

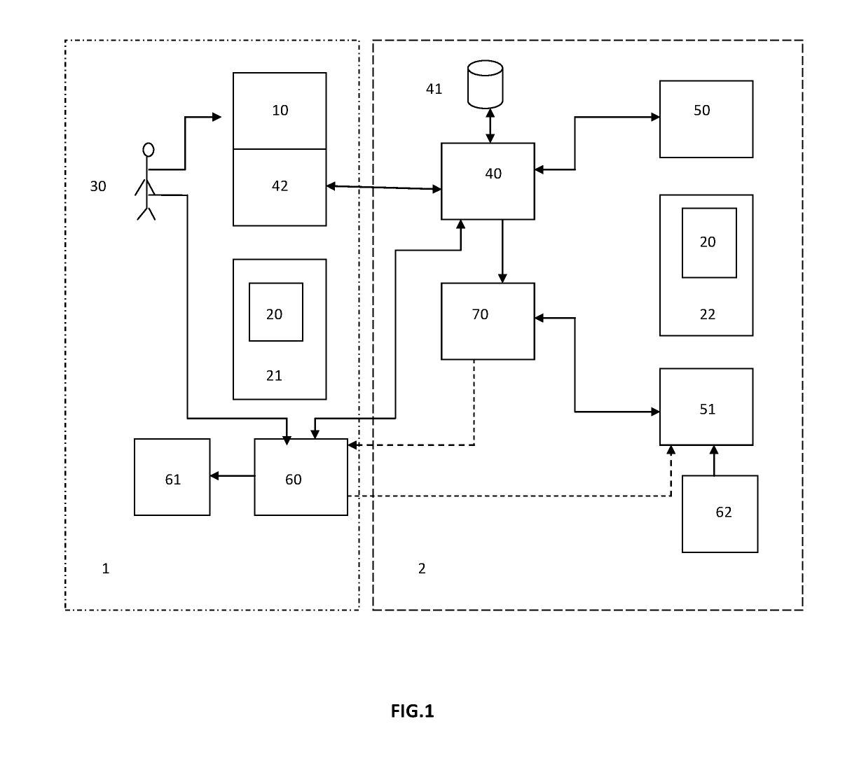

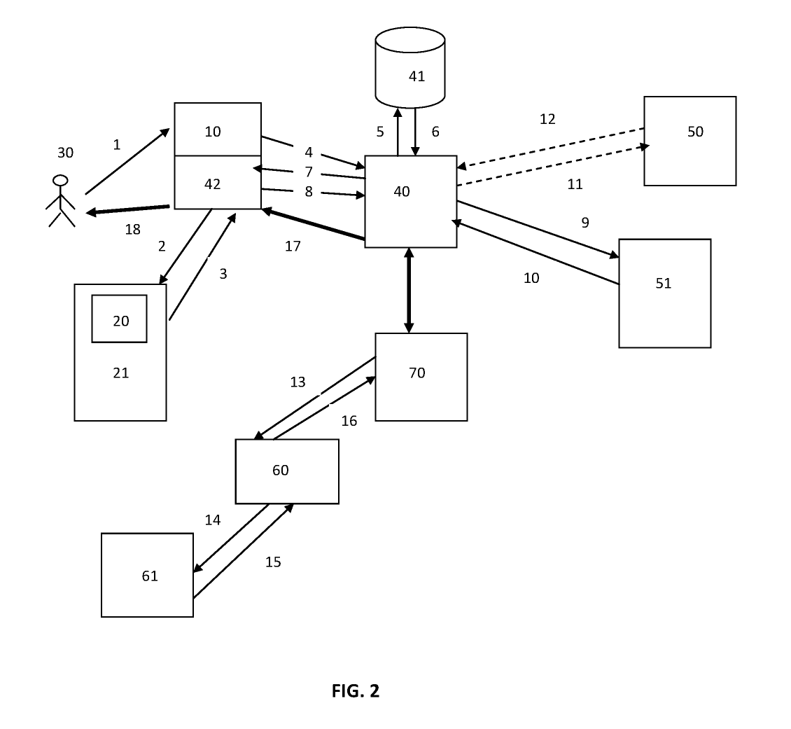

FIG. 2 represents the various steps of the method for preparing and processing a signature request, by a business application 10, of a document 20 with a signature manager 40 for a user 30, registered and identified with said signature manager 40, implemented in the system of the invention and comprising the steps below. Each step corresponds to one or more numbers represented by arrows.
Connection of a user 30 to the business application 10 to sign a document 20 of its local environment 21. (arrow No. 1).
Recovery by the business application of the document to be signed. (arrow no 2 and 3).
Querying the signature manager 40 by the business application 10 to identify the user 30 who must sign the document 20. (arrow No. 4).
Sending a signature request to said signature manager 40 by the business application 10, said request includes content to be signed, identification and selection criteria of the signatory user, a type of digital identity to use signature properties, and a signature format. (arrow no 8).
Coordination of the steps of the signature transaction by the signature manager 40 comprising the following steps:
Verification of the identity and the authorization of the business application 10 and the signatory user 30 (arrows no 5, 6);
Recovery of the document 20 to sign with the business application 10 (arrow No. 7).
Preparation of the signature request with the calculation of the fingerprint of the data to be signed, via signature servers 50 or 51. (arrows No. 9, 10 or 11, 12).
Sending a notification of the signature request to a signature service 60 of the user 30 by means of the notification server 70. (arrows 13 and 16).
Control execution of the signature process by the signature service 60 (arrows 14 and 15) by activating a private key corresponding to a certificate of the user 30 meeting the selection criteria sent to said signature manager 40 by the business application 10.
Timestamping and saving transaction events in logs;
Sending to the business application 10 the result of operations after notification, or errors possibly encountered. (arrow no 17).
Recovery by the business application 10 of the results of operations;
Provision of the user 30 by the business application 10 of the result (arrow No. 18)

Many combinations can be envisaged without departing from the scope of the invention; for example, the document to be signed can be accessible to the user locally, on his workstation, or remotely, in a network environment. Similarly, the signature creation device can be accessible locally, in the form of a smart card for example, or remotely, in the network environment of the system, in the form of a signature server with generation certificate on-the-fly. Also, the signature manager can be accessed locally or via the network. The skilled person will choose one or the other of the different possibilities according to the economic, ergonomic, dimensional or other constraints that he must respect.

1. Open and secure electronic signature system comprising a business application (10), developed and executed in a variety of environments, said business application (10) having a programming interface (42) configured to request a signature of a document (20) with a signature manager (40) for a user (30), characterized in that said business application (10) is able to define a content to be signed, to identify criteria and to select a signatory user (30), to define the use of a type of digital identity, that it is further able to perform a collection of signature properties and to require a signature format; in that said signature manager (40) is able to coordinate said signature request by performing the following steps:—verification of the identity and the authorization of the business application (10),—verification of the identity of the signing user (30),—recovering the document (20) to be signed,—preparing the signature request with the finger print calculations to be signed, via signature servers (50, 51),—sending a notification of the signature request via a notification server (70) to the signature services (60) of the user (30); and in that the user (30), by means of said signature services (60), is able to control the execution of the signature process by activating the private key corresponding to a certificate (61) of the user (30).) responding to the selection criteria sent to said signature manager (40) by the business application (10) to encrypt the fingerprint of the data to be signed.

2. System according to claim 1, characterized in that the signature manager (40) is able to identify the identity of the signatory user (30) by means of a user directory (41) managed by said signature manager (40), in that the fingerprint calculations of the data are performed either by a signature server (50) or by a reverse signature server (51) and in that the signature manager (40) is furthermore able to recovering the signatures made and to sending said signatures to the business application (10), the notification server (70) being configured to previously notify said business application (10) of the arrival of said signatures.

3. System according to claim 1 characterized in that it further comprises timestamped and archived log files, in which are written the steps of the signature transaction, and in that the signature manager (40) is configured to manage said files logs to form a proof file for each signature transaction.

4. System according to claim 1, characterized in that the signature service (60) is a lightweight and downloadable software component on a user's device (30) and in that said device is a PC and/or a Mac and/or a tablet and/or a smartphone of said user.

5. System according to claim 1, characterized in that it further comprises a personal signature manager (41) belonging to the user (30), in that the business application (10) is able to make a signature request with said personal signature manager (41), and said personal signature manager (41) executes on a device of said user (30) so as to allow said user to sign a document in local mode when there is no internet connection available or that the signature manager (40) is not usable in this context.

6. System according to claim 1, characterized in that it furthermore comprises a local signature creation device (61), in the form of a hardware or software component, and/or a remote signature creation device. (62), the user (30) is capable of signing the document (20) either using said local signature-creating device (61) using the hardware component, such as a cryptographic device, or the component software, such as a software certificate accessible on the user's device (30), or using the remote signature creation device (62), said remote signature creation device (62) being able to incorporating a certificate generated on-the-fly, during a movement of said user (30).

7. System according to claim 6 characterized in that said certificates generated on-the-fly are generated so that they have a level of security in accordance with the requirements formulated in the signature request sent by the business application (10) and that they are able to perform the encryption of the fingerprint of the data to be signed by an associated private key.

8. System according to claim 1 wherein the business application (10) accesses the data to be signed, said data to be signed are located either in the local environment of said business application (10), or in the environment network of said business application (10).

9. System according to claim 6 wherein the local signature creation device (61) is in the form of a cryptographic chip or a software certificate, the user (30) locally accesses said local signature creation device. (61) from its device, said device being a workstation, or a smartphone or tablet.

10. System according to claim 6, characterized in that the remote signature creation device (62) is located in the network environment of the signature manager (40) and contains a certificate generated on-the-fly, that system comprises an infrastructure key management system capable of generating said certificate on-the-fly, and in that the private key associated with said certificate on-the-fly is generated and stored securely by the signature servers (50, 51).

11. System according to claim 6, characterized in that the signature manager (40) by means of the notification server (70) is able to notify the signature request of the document (20) to the signature services (60) of the user (30), and that the notification server (70) is associated with an execution environment of said signature services (60).

12. System according to claim 11, in which the signature service (60) is configured to register with the notification server (70) associated with its execution environment and is able to communicate with the signature manager (40) in order to indicate to him that he knows the information enabling said signature manager to notify him.

13. A method for preparing and processing a request for signature, by a business application (10), of a document (20) to a signature manager (40) for a user (30), registered and identified with said signature manager (40), implemented in the system according to one of claims 1 to 12 comprising the following steps:
connecting the user (30) to the business application (10) to sign the document (20);
recovery by the business application (10) of the document (20) to be signed;
querying the signature manager (40) by the business application (10) to identify the user (30) to sign the document (20);
sending a signature request to said signature manager (40) by the business application (10), said request includes a content to be signed, criteria for identifying and selecting the signatory user, a type of digital identity to use, it performs a collection of signature properties and requires a signature format;
coordination of the signature transaction steps by the signature manager (40) comprising the following steps:
verification of the identity and the authorization of the business application (10);
verification of the identity of the signatory user (30);
recovering said document (20) to be signed with the business application (10);
preparing the signature request with the calculation of the fingerprint of the data to be signed via signature servers (50, 51);
sending a notification of the signature request to the signature services (60) of the user (30) via a notification server (70);
control of the execution of the signature process by the signature services (60), by activating a private key corresponding to a certificate of the user (30) meeting the selection criteria sent to said signature manager (40) by the business application (10);
timestamping and saving transaction events in logs;
sending to the business application (10) the result of the operations after notification, or any errors encountered;
recovery by the business application (10) of the results of operations;
providing the user (30) with the business application (10) of the result of the operations.
